(19) United States
(12) Patent Application Publication
(10) Pub. No.: US 2023/0049945 A1
(43) Pub. Date: Feb. 16, 2023

(54) ELECTRONIC DEVICE INDICATING OCCURRENCE OF EVENT AND METHOD FOR CONTROLLING THE SAME

(71) Applicant: Samsung Electronics Co., Ltd., Suwon-si (KR)

(72) Inventor: Hyewon SEO, Suwon-si (KR)

(21) Appl. No.: 17/885,004

(22) Filed: Aug. 10, 2022

Related U.S. Application Data
(63) Continuation of application No. PCT/KR2022/011869, filed on Aug. 9, 2022.

(30) Foreign Application Priority Data
Aug. 10, 2021 (KR) 10-2021-0105711
Jan. 28, 2022 (KR) 10-2022-0013132

(51) Int. Cl. G06F 3/0481; G06F 3/0484

(52) U.S. Cl. CPC G06F 3/0481; G06F 3/0484

(57) ABSTRACT

An electronic device is provided. An electronic device includes a display and at least one processor. The at least one processor may display a first object including a status of the electronic device in a first area which is a portion of the display and, in response to an event occurring, move at least a portion of the first object from a first area to a second area different from the first area.

### CROSS-REFERENCE TO RELATED APPLICATION(S)

This application is a continuation application, claiming priority under § 365(c), of an International application No. PCT/KR2022/011869, filed on Aug. 9, 2022, which is based on and claims the benefit of a Korean patent application number 10-2021-0105711, filed on Aug. 10, 2021, in the Korean Intellectual Property Office, and of a Korean patent application number 10-2022-0013132, filed on Jan. 28, 2022, in the Korean Intellectual Property Office, the disclosure of each of which is incorporated by reference herein in its entirety.

### TECHNICAL FIELD

The disclosure relates to an electronic device indicating an occurrence of an event and a method for controlling the same.

### BACKGROUND ART

More and more services and additional functions are being provided through electronic devices, e.g., smartphones, or other portable electronic devices. To meet the needs of various users and raise use efficiency of electronic devices, communication service carriers or device manufacturers are jumping into competitions to develop electronic devices with differentiated and diversified functionalities. Accordingly, various functions that are provided through electronic devices are evolving more and more.

The above information is presented as background information only to assist with an understanding of the disclosure. No determination has been made, and no assertion is made, as to whether any of the above might be applicable as prior art with regard to the disclosure.

### DISCLOSURE

### Technical Problem

When a new event occurs in an application serviced by the electronic device, the electronic device may display an icon related to the event on a notification bar at the top of the display to indicate the occurrence of the event.

In the case of indicating the occurrence of an event by displaying an icon on the notification bar as described above, a portion of the display area must be used as the notification bar, and thus the area of use of the display may be reduced.

Further, since the occurrence of an event may be identified only when the user intentionally checks the notification bar, the user may miss the event.

Aspects of the disclosure are to address at least the above-mentioned problems and/or disadvantages and to provide at least the advantages described below. Accordingly, an aspect of the disclosure is to provide an electronic device capable of attracting the user's attention and notifying the user of the occurrence of an event while utilizing a wider area of the device and a method for controlling the same.

Additional aspects will be set forth in part in the description which follows and, in part, will be apparent from the description, or may be learned by practice of the presented embodiments.

### Technical Solution

In accordance with an aspect of the disclosure, an electronic device is provided. The electronic device includes a memory, a display and at least one processor coupled to the memory and the display. The at least one processor may display a first object including a status of the electronic device in a first area which is a portion of the display and, if an event occurs, move at least a portion of the first object from a first area to a second area in the display, the second area being different from the first area.

In accordance with another aspect of the disclosure, a method for controlling an electronic device is provided. The method includes displaying a first object including a status of the electronic device in a first area which is a portion of a display of the electronic device and, when an event occurs, moving at least a portion of the first object from the first area to a second area in the display, the second area being different from the first area.

### Advantageous Effects

According to various embodiments of the disclosure, when an event occurs, the electronic device may effectively provide the user with the occurrence of the event by moving a portion of an object displayed on the display.

Further, according to various embodiments of the disclosure, the electronic device may more effectively provide the state of the electronic device to the user by differently representing the object displayed in the first area depending on the battery charge amount and moving a portion of the object, displayed in the first area, to the second area when an event occurs.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2A is an example view illustrating an unfolded state of an electronic device (e.g., the electronic device 101 of FIG. 1) according to an embodiment of the disclosure;

FIG. 2B is an example view illustrating a folded state of the electronic device of FIG. 2A according to an embodiment of the disclosure;

FIG. 2C is an example view illustrating a folded state of an electronic device according to an embodiment of the disclosure;

FIG. 3 is a flowchart illustrating an event notification operation by an electronic device according to an embodiment of the disclosure;

FIG. 4A is a view illustrating an event notification operation according to an embodiment of the disclosure;

FIG. 4B is a view illustrating an event notification operation according to an embodiment of the disclosure;

FIG. 4C is a view illustrating an event notification operation according to an embodiment of the disclosure;

FIG. 5 is a view illustrating an operation of displaying an application where an event occurs according to an embodiment of the disclosure;

FIG. 6 is a flowchart illustrating an event notification operation based on a state of an electronic device according to an embodiment of the disclosure;

FIG. 7 is a view illustrating an object which is displayed when a battery charge amount of an electronic device is less than a set value according to an embodiment of the disclosure;

FIG. 8 is a view illustrating an object displayed when a new event occurs or when a battery charge amount is less than a set value according to an embodiment of the disclosure;

FIG. 9A is a view illustrating an application mapped to be executed by a swipe on a border of a display according to an embodiment of the disclosure;

FIG. 9B is a view illustrating an event notification operation according to an embodiment of the disclosure;

FIG. 9C is a view illustrating an event notification operation according to an embodiment of the disclosure;

FIG. 9D is a view illustrating an event notification operation according to an embodiment of the disclosure;

FIG. 9E is a view illustrating an event notification operation according to an embodiment of the disclosure;

FIG. 9F is a view illustrating an event notification operation according to an embodiment of the disclosure;

FIG. 10A is a view illustrating an event notification operation when an icon corresponding to an application where an event occurs is displayed according to an embodiment of the disclosure; and

FIG. 10B is a view illustrating an event notification operation when an icon corresponding to an application where an event occurs is displayed according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

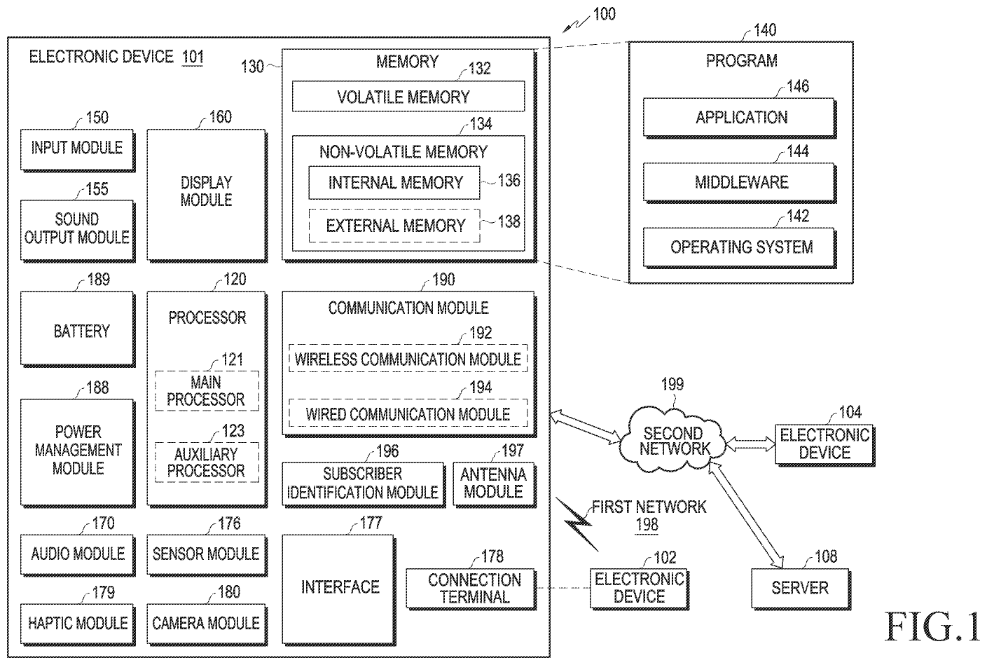

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5th generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave band)) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

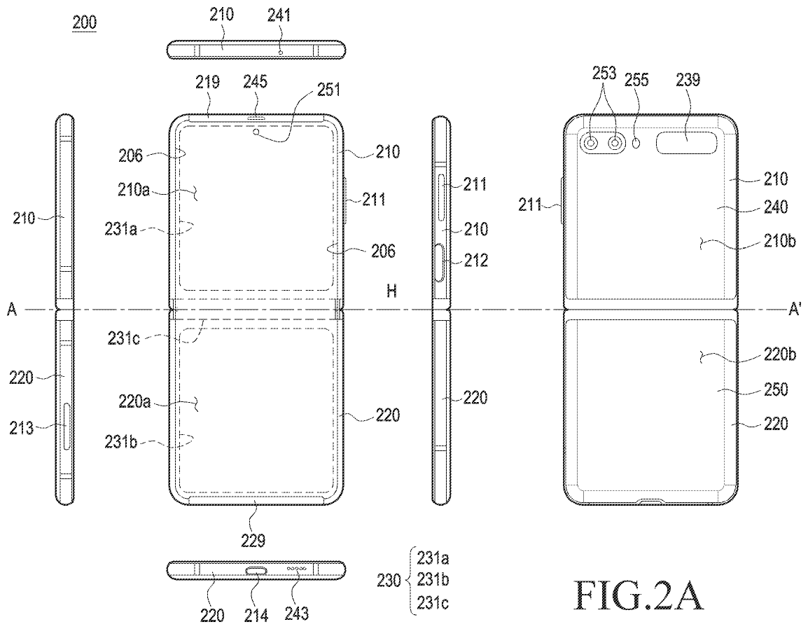

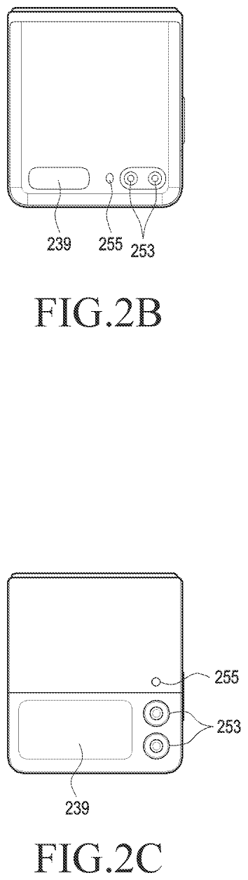

FIG. 2A is an example view illustrating an unfolded state of a foldable-type electronic device 200 according to an embodiment of the disclosure.

Referring to FIG. 2A, according to an embodiment of the disclosure, an electronic device 200 may be a foldable type which is foldable or unfoldable and may include a first housing 210, a second housing 220, and a flexible or foldable display 230 (e.g., the display module 160 of FIG. 1) disposed in a space provided by the first housing 210 and the second housing 220.

According to an embodiment of the disclosure, the surface on which the display 230 is disposed may be defined as a front surface of the electronic device 200. At least part of the front surface of the electronic device may have a substantially transparent front plate (e.g., a glass plate or polymer plate including various coat layers). The opposite surface to the front surface may be defined as a rear surface of the foldable device 200. The rear of the foldable device 200 may be formed by a substantially opaque rear plate (hereinafter, referred to as a ‘rear cover’). The rear cover may be formed of, e.g., laminated or colored glass, ceramic, polymer, metal (e.g., aluminum, stainless steel (STS), or magnesium), or a combination of at least two thereof. The surface surrounding the space between the front and rear surfaces may be defined as a side surface of the foldable device 200. The side surface may be formed by a side bezel structure (or a “side member”) that couples to the front plate and the rear plate and includes a metal and/or polymer. According to an embodiment, the rear cover and the side bezel plate may be integrally formed together and include the same material (e.g., a metal, such as aluminum).

According to an embodiment of the disclosure, the foldable device 200 may include at least one or more of a display 230, a microphone hole 241, speaker holes 243 and 245, a sensor module 255, a camera module 253, key input devices 211, 212, and 213, and a connector hole 214. According to an embodiment, the foldable device 200 may omit at least one (e.g., the key input devices 211, 212, 213) of the components or additionally include another component (e.g., a light emitting device).

According to an embodiment of the disclosure, the display 230 may be a display having at least a partial area transformable to be flat or curved. According to an embodiment, the display 230 may include a folding area 231c, a first area 231a disposed on one side of the folding area 231c (e.g., an upper side of the folding area 231c of FIG. 2A), and a second area 231b disposed on the opposite side of the folding area 231c (e.g., a lower side of the folding area 231c of FIG. 2A). However, the segmentation of the display 230 as shown in FIG. 2A is merely an example, and the display 230 may be divided into a plurality of (e.g., four or more, or two) areas depending on the structure or function of the display 230. For example, in the embodiment illustrated in FIG. 2A, the display 230 may be divided into the areas by the folding area 231c or folding axis A but, in another embodiment, the display 230 may be divided into the areas with respect to another folding area 231c or another folding axis (e.g., a folding axis perpendicular to the folding axis A).

According to an embodiment of the disclosure, the microphone hole 241 may have a microphone inside to obtain external sounds. According to an embodiment, there may be a plurality of microphones to be able to detect the direction of a sound. The speaker holes 243 and 245 may include an external speaker hole 243 and a phone receiver hole 245. According to an embodiment, the speaker holes 243 and 245 and the microphone hole 241 may be implemented as a single hole, or speakers may be rested without the speaker holes 243 and 245 (e.g., piezo speakers). Various changes may be made to the position and number of microphone holes 241 and speaker holes 243 and 245 according to an embodiment.

According to an embodiment of the disclosure, the camera module 253 may include a first camera device 251 disposed on a first surface 210a of the first housing 210 of the foldable device 200 and a second camera device 253 disposed on a second surface 210b. Further, the foldable device 200 may further include a flash (not shown). The camera devices 251 and 253 may include one or more lenses, an image sensor, and/or an image signal processor. The flash (not shown) may include, e.g., a light emitting diode (LED) or a xenon lamp.

According to an embodiment of the disclosure, the sensor module 255 may generate an electrical signal or data value corresponding to an internal operating state or external environmental state of the foldable device 200. Although not shown in the drawings, the foldable device 200 may additionally or alternatively include a sensor module (e.g., the sensor module 176 of FIG. 1) other than the sensor module 255 provided on the second surface 210b of the first housing 210. According to an embodiment of the disclosure, the foldable device 200 may further include at least one of a proximity sensor, a fingerprint sensor, an HRM sensor, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, an angle sensor, or an illuminance sensor, as the sensor module. According to an embodiment of the disclosure, in a folded state of the foldable device 200, the foldable device 200 may distinguish the upper surface and the lower surface of the foldable device using data obtained by the gyro sensor. For example, according to an embodiment of the disclosure, if the data obtained by the gyro sensor is substantially changed from data at a specific time, the foldable device 200 may determine that the surface where the gyro sensor is provided is the upper surface. In contrast, according to an embodiment of the disclosure, if the data obtained by the gyro sensor is not substantially changed from the data at the specific time, the foldable device 200 may determine that the surface where the gyro sensor is provided is the lower surface. According to an embodiment of the disclosure, the foldable device 200 may determine the folding angle of the foldable device 200 through an angle sensor disposed around the folding axis A. However, according to various embodiments of the disclosure, various techniques for determining the folding angle of the foldable device 200 may be applied to embodiments of the disclosure.

According to an embodiment of the disclosure, the key input devices 211, 212, and 213 may be disposed on a side surface of the foldable housing (e.g., the first housing 210 or the second housing 220). According to another embodiment, the electronic device 200 may exclude all or some of the above-mentioned key input devices 211, 212, and 213 and the excluded key input devices may be implemented in other forms, e.g., as soft keys, on the display 230. In some embodiments, the key input device may be configured to implement key input by a sensor module (e.g., a gesture sensor).

According to an embodiment of the disclosure, the connector hole 214 may be configured to receive a connector (e.g., a USB connector) for transmitting/receiving power and/or data to/from an external electronic device or, additionally or alternatively, a connector for transmitting/receiving audio signals to/from an external electronic device.

According to an embodiment of the disclosure, a foldable housing may be implemented by a combination of the first housing 210, the second housing 220, the first rear cover 240, the second rear cover 250, and the hinge module. According to an embodiment of the disclosure, the foldable housing of the foldable device 200 is not limited to the shape and coupling shown in FIG. 2A but may rather be implemented in other shapes or via a combination and/or coupling of other components. For example, in another embodiment, the first housing 210 and the first rear cover 240 may be integrally formed with each other, and the second housing 220 and the second rear cover 250 may be integrally formed with each other. According to various embodiments of the disclosure, ‘housing’ may mean a combination of other various components not mentioned and/or a combined configuration thereof. For example, it may be described that a first area 231a of the display 230 forms one surface of the first housing 210 and, in another embodiment, the first area 231a of the display 230 is disposed or attached to one surface of the first housing 210.

According to an embodiment of the disclosure, the first housing 210 may be connected to a hinge structure and may include a first surface 210a facing in a first direction and a second surface 210b facing in a second direction opposite to the first direction. The second housing 220 may be connected to the hinge structure and may include a third surface 220a facing in a third direction and a fourth surface 220b facing in a fourth direction opposite to the third direction and may be rotated or pivoted from the first housing 210 around the hinge structure (or folding axis A).

According to an embodiment of the disclosure, the first housing 210 and the second housing 220 may be disposed on two opposite sides (or upper/lower sides) of the folding axis A and may overall have a symmetrical shape with respect to the folding axis A. The angle or distance between the first housing 210 and the second housing 220 may be varied depending on whether the electronic device 200 is in the unfolded state, the folded state, or the partially unfolded (or partially folded) intermediate state. According to an embodiment, the first housing 210 may further include various sensors unlike the second housing 220 but, in the remaining area, the first housing 210 and the second housing 220 may have symmetrical shapes with each other.

According to an embodiment of the disclosure, the first housing 210 and the second housing 220 may at least partially be formed of a metal or non-metallic material with a rigidity selected to support the display 230. The at least a portion formed of the metal material may be provided as a ground plane or radiating conductor of the foldable device 200 and, if provided as the ground plane, it may be electrically connected with a ground line formed on the printed circuit board.

According to an embodiment of the disclosure, the first rear cover 240 may be disposed on one side (e.g., the upper side in FIG. 2A) of the folding axis A, on the rear surface of the foldable device 200, e.g., it may have a substantially rectangular periphery which may be surrounded by the first housing 210 (and/or the side bezel structure). Similarly, the second rear cover 250 may be disposed on the opposite side (e.g., the lower side in FIG. 2A) of the folding axis A on the rear surface of the foldable device 200 and its periphery may be surrounded by the second housing 220 (and/or the side bezel structure).

According to an embodiment of the disclosure, the first rear cover 240 and the second rear cover 250 may be substantially symmetrical in shape with respect to the folding axis A. However, the first rear cover 240 and the second rear cover 250 are not necessarily symmetrical in shape. In another embodiment, the foldable device 200 may include the first rear cover 240 and the second rear cover 250 in various shapes. In another embodiment, the first rear cover 240 may be integrally formed with the first housing 210, and the second rear cover 250 may be integrally formed with the second housing 220.

According to an embodiment of the disclosure, the first rear cover 240, the second rear cover 250, the first housing 210, and the second housing 220 may form a space where various components of the foldable device 200 may be disposed. According to an embodiment, one or more components may be arranged or visually exposed on/through the rear surface of the foldable device 200. For example, at least a portion of a sub display 239 may be visually exposed through the first rear cover 240. In another embodiment, one or more components or sensors may be visually exposed through the first rear cover 240. According to various embodiments, the components or sensors may include a proximity sensor, a rear camera, and/or a flash. Although not separately shown in the drawings, one or more other components or sensors may be visually exposed through the second rear cover 250.

According to an embodiment of the disclosure, the front camera 251 exposed from the front surface of the foldable device 200 through one or more openings or the rear camera 253 exposed through the first rear cover 240 may include one or more lenses, an image sensor, and/or an image signal processor. The flash (not shown) may include, e.g., a light emitting diode (LED) or a xenon lamp. According to an embodiment, two or more lenses (an infrared (IR) camera, a wide-angle lens, and a telescopic lens) and image sensors may be disposed on one surface of the foldable device 200.

According to an embodiment of the disclosure, the foldable device 200 may transform to a folded status or an unfolded status.

For example, the first housing 210 and the second housing 220 may be pivoted about each other between a first position, in which they face each other, and a second position (e.g., the status shown in FIG. 2A) unfolded from the first position by a designated angle. FIG. 2A exemplifies an unfolded state of the first housing 210 and the second housing 220 which form about 180 degrees therebetween. In the folded state, e.g., the first position, the first area 231a and the second area 231b of the display 230 are positioned to face each other, and the folding area 231c may be deformed into a curved shape.

According to an embodiment of the disclosure, the foldable device 200 may be implemented as two types, ‘in-folding’ in which the first area 231a and the second area 231b are folded to face each other, and ‘out-folding’ in which the first area 231a and the second area 231b are folded in face in opposite directions. For example, in the in-folding folded state, the first area 231a and the second area 231b may be substantially hidden and, in the fully unfolded state, the first area 231a and the second area 231b may be disposed to face substantially in the same direction. As another example, in the out-folding folded state, the first area 231a and the second area 231b are disposed to face in opposite directions, exposed to the outside and, in the fully unfolded state, the first area 231a and the second area 231b may be disposed to face substantially in the same direction. According to an embodiment, the folded state is described with reference to FIGS. 2B and 2C.

According to an embodiment of the disclosure, the display 230 may include a display panel and a window member and may be formed of a flexible material. Although not separately shown, it will be appreciated by one of ordinary skill in the art that the display 230 or display panel includes various layers, such as a light emitting layer, a substrate(s) for encapsulating the light emitting layer, an electrode or wiring layer, and/or adhesive layer(s) for bonding different layers. According to an embodiment of the disclosure, when the display 230 (e.g., the folding area 231c) is deformed into a flat or curved shape, a relative displacement may occur between the layers constituting the display 230. The relative displacement due to the deformation of the display 230 may increase as it is farther away from the folding axis A and/or as the thickness of the display 230 increases.

According to an embodiment of the disclosure, the window member may serve as a protection film for protecting the display panel. As a protection film, a thin film plate may be formed of a material that protects the display panel from external impact, is robust against scratches, and causes fewer creases in the folding area 231c when the housings 210 and 220 are repeatedly folded and unfolded. For example, the material of the thin film plate may include a clear polyimide (CPI) film or ultra-thin glass (UTG).

According to various embodiments, the foldable device 200 may further include a protection member(s) 206 or ornamental covers 219 and 229 disposed at at least a portion of the edge of the display 230 on the front surface (e.g., the front surface 210a or the third surface 220a). The protection member 206 or ornamental covers 219 and 229 may prevent at least a portion of the edge of the display 230 from contacting a mechanical structure (e.g., the first housing 210 or the second housing 220) and provide a decorative effect to the outer appearance of the foldable device 200.

FIG. 2B is an example view illustrating a folded state of the foldable device of FIG. 2A according to an embodiment of the disclosure. For example, FIG. 2B illustrates an ‘in-folding’ folded state.

Referring to FIG. 2B, the electronic device (e.g., the electronic device 101 of FIG. 1 or the foldable device 200 of FIG. 2A) may change from the unfolded state as shown in FIG. 2A to the folded state.

According to an embodiment, in the ‘in-folding’ folded state of the electronic device, the first area (e.g., the first area 231a of FIG. 2A) and second area (e.g., the second area 231b of FIG. 2A) of the flexible display (e.g., the display module 160 of FIG. 1) are folded to face each other to be substantially hidden.

According to an embodiment, the first rear cover (e.g., the first rear cover 240 of FIG. 2A) and the second rear cover (e.g., the second rear cover 250 of FIG. 2A), which are disposed to face in the same direction in the unfolded state, are disposed to face in opposite directions to be exposed to the outside in the folded state.

According to an embodiment, in the folded state, one or more components may be disposed or visually exposed through the first rear cover (or the second rear cover). For example, in the folded state, at least a portion of the sub display 239, the sensor module 255 (e.g., a proximity sensor), the rear camera 253, and/or the flash may be visually exposed through the first rear cover (or second rear cover).

According to an embodiment, in the folded state, the electronic device may provide content through the sub display 239. For example, the content may include a standby screen or an application execution screen. For example, the standby screen may include notification information, such as date information, time information, battery charge amount information, and/or event occurrence.

According to an embodiment, the shape and/or size of the sub display 239, and the type, size, and/or arrangement of the sub display 239, sensor module 255, and/or rear camera 253 may differ from those shown in FIG. 2C.

FIG. 2C is an example view illustrating a folded state of a foldable device according to an embodiment of the disclosure.

Referring to FIG. 2C, the rear camera 253 may be oriented vertically unlike that shown in FIG. 2A, the size of the sub display 239 may have the vertical length longer than that shown in FIG. 2A, and the sensor module 255 may be disposed on the rear camera 253, rather than between the sub display 239 and the rear camera 253 unlike that shown in FIG. 2A.

According to an embodiment, the type, shape, size, and/or arrangement of the sub display 239, sensor module 255, and rear camera 253 in FIGS. 2B and 2C is merely an example, and embodiments of the disclosure are not limited thereto. For example, the sub display 239 is rectangular with curved corners in FIGS. 2B and 2C, but it may have a circular or square shape.

According to an embodiment, the type and/or number of at least one component visually exposed through the rear cover (e.g., the first rear cover or the second rear cover) is not limited to those shown in FIGS. 2B and 2C.

According to an embodiment, although FIGS. 2B and 2C illustrate that the electronic device is folded in the ‘in-folding’ type, it may also be folded in the ‘out-folding’ type. If the electronic device is folded in the ‘out-folding’ type, one of the first area (e.g., the first area 231a of FIG. 2A) and the second area (e.g., the second area 231b of FIG. 2A) of the externally exposed flexible display (e.g., the display module 160 of FIG. 1) may be the sub display 239.

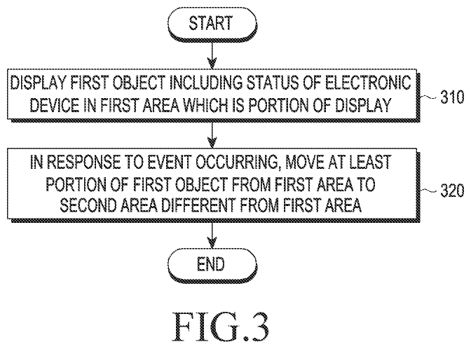

FIG. 3 is a flowchart illustrating an event notification operation by an electronic device according to an embodiment of the disclosure.

Referring to FIG. 3, in operation 310, the electronic device (e.g., the electronic device 101 of FIG. 1, the processor 120 of FIG. 1, or the foldable device 200 of FIG. 2A) may display a first object including the status of the electronic device in a first area which is a portion of the display (e.g., the display module 160 of FIG. 1, the sub display 239 of FIG. 2A, the sub display 239 of FIG. 2B, or the sub display 239 of FIG. 2C).

According to an embodiment, the electronic device may be a bar-shaped electronic device, a slidable electronic device, or a foldable electronic device (e.g., the foldable device 200 of FIG. 2A). According to an embodiment, if the electronic device is a bar-shaped electronic device or a slidable electronic device, the electronic device may display the first object on the display disposed on the front surface of the electronic device. According to an embodiment, if the electronic device is a foldable electronic device, the electronic device in its folded state may display the first object on a cover screen (e.g., the sub display 239 of FIG. 2A, the sub display 239 of FIG. 2B, or the sub display 239 of FIG. 2C) disposed on the externally exposed rear cover (e.g., the first rear cover 240 of FIG. 2A).

According to an embodiment, the first object may be a character image indicating the status of the electronic device. For example, the character image may include a moving image.

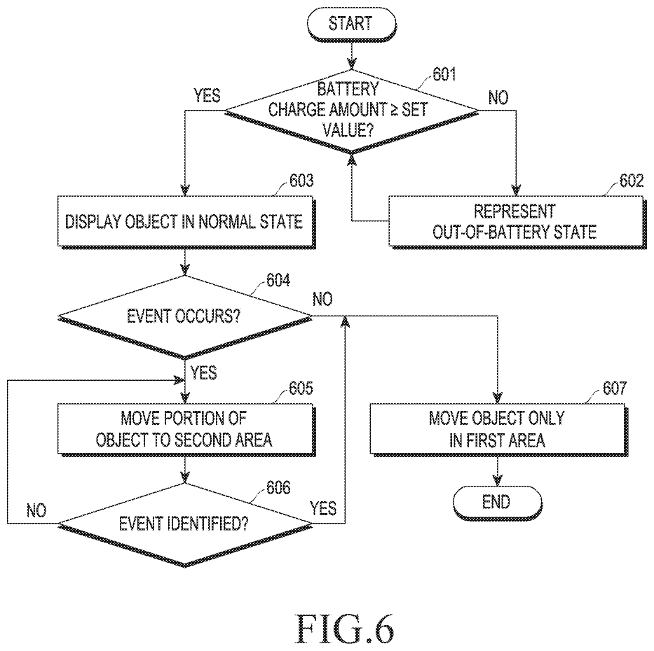

According to an embodiment, the first object may include another character image based on the battery charge amount. For example, the electronic device may identify the battery charge amount and, if the battery charge amount is a set value (e.g., 15%) or higher, display the first object including a first character image. For example, if the battery charge amount is less than the set value (e.g., 15%), the electronic device may display the first object including a second character image (e.g., a tired face or text ‘ZZZ’). According to an embodiment, the operation of displaying the first object based on the battery charge amount is described below with reference to FIGS. 6 to 8.

According to an embodiment, the electronic device may control the display to further display a clock object, a date object, and/or a battery charge amount object together with the first object. For example, the clock object may include time information and may be in the form of a digital clock or an analog clock. For example, the date object may include date information and day information. The battery charge amount object may include battery charge amount information.

According to an embodiment, the type of the object displayed on the display (e.g., the cover screen) may be set by a user input. For example, the user may enter the settings screen of the display through a menu touch or long press to set the type of the object.

According to an embodiment, the electronic device may control the display to display a portion of the clock object, the date object, and/or the battery charge amount object and a portion of the first object to be overlaid on each other.

As described above, the object displayed on the display is merely an example and is not limited thereto.

According to an embodiment, in operation 320, in response to an event occurring, the electronic device may move at least a portion of the first object from a first area to a second area different from the first area. For example, the event may include a case where it is necessary to provide a notification to the user as an application providing a service on the electronic device is updated with new information. For example, the event may include receiving a new message, alarming, and/or recommending a content.

According to an embodiment, when no event occurs, the electronic device may control the display to display the first object only in the first area of the display.

According to an embodiment, if an event occurs, the electronic device may display a second object indicating the occurrence of the event in a portion of the second area. For example, the second object may include a figure (e.g., a dot or polygon) image and including an icon related to the application where the event occurs.

According to an embodiment, the display may include one second area or may include two or more second areas.

According to an embodiment, the electronic device may move a portion of the first object from the first area to the surroundings of the second object displayed in the second area. For example, the electronic device may control the display so that a portion of the first object appears to fly around the displayed second object according to the occurrence of the event.

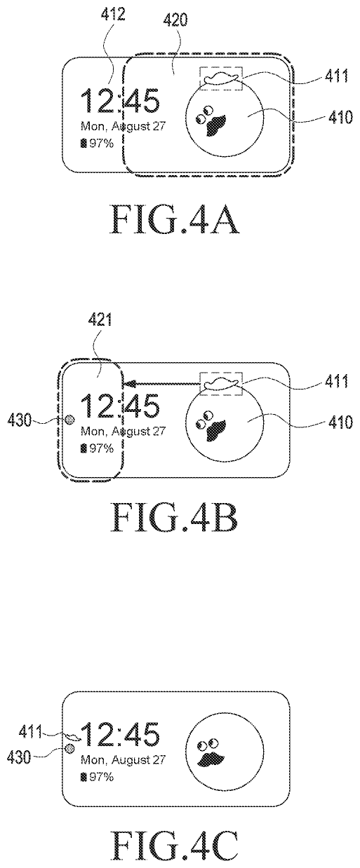

According to an embodiment of the disclosure, the operation for the electronic device indicating an occurrence of an event is described below with reference to FIGS. 4A to 4C.

According to an embodiment, if a user input of touching the second object is received, the electronic device may display the screen of the application where the event occurs. For example, if the user input of touching the second object is received to indicate the occurrence of the event, the electronic device may display the screen of the application related to the occurring event. For example, in a case where a new message is received, if a user input of selecting the second object is received, the electronic device may display a message application screen including the received new message.

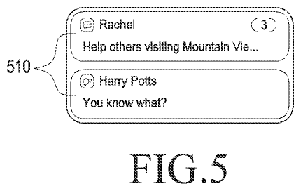

According to an embodiment, the operation of displaying an application screen related to an event based on reception of a user input of selecting a second object is described below with reference to FIG. 5.

According to an embodiment, in a case where there are a plurality of applications respectively mapped to a plurality of borders of the display to be executed through a swipe starting from a border of the display, if an event occurs in one of the plurality of applications, the electronic device may display the second object in a second area corresponding to a first border of the display corresponding to the application where the event occurs, among the plurality of second areas corresponding to the plurality of borders, respectively.

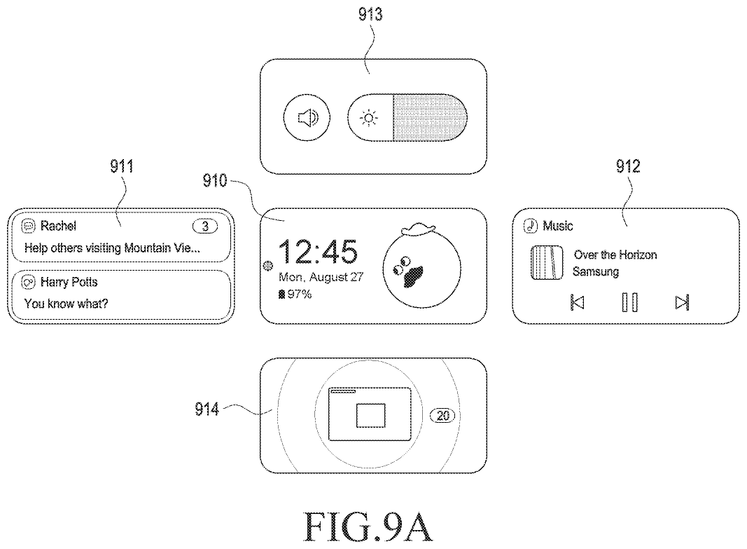

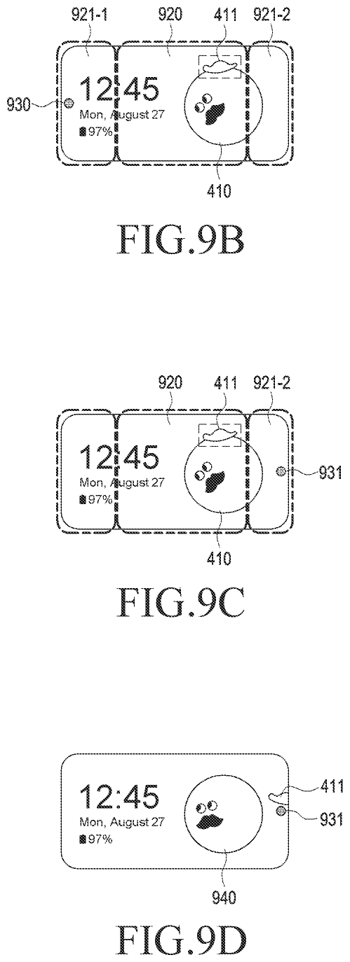

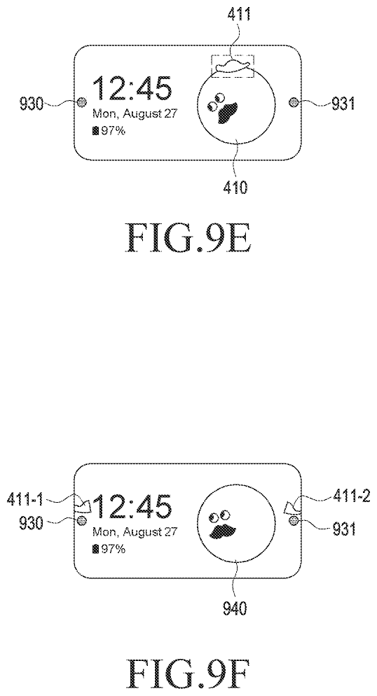

For example, in a case where there is at least one application respectively mapped to at least one of a plurality of borders (e.g., top, bottom, left, and right) of the display, if the electronic device receives a user input of performing a swipe from one border among the at least one borders, the electronic device may control the display to display the execution screen of the application corresponding to the border where the swipe starts. According to an embodiment, the operation of executing an application through a swipe starting from a border is described below in detail with reference to FIG. 9A.

According to an embodiment, in a case where there is at least one application respectively mapped to at least one of the display, the display may include at least one second area including the application-mapped border.

According to an embodiment, if an event occurs at a portion of at least one application respectively mapped to at least one border, the electronic device may control the display to move a portion of the first object to the second area including the border area corresponding to the event-occurring application.

According to an embodiment, if an event occurs at a portion of the at least one application respectively mapped to at least one border, the electronic device may control the display to display the second object indicating that the event occurs in the second area including the border area corresponding to the event occurring application and move at least a portion of the first object from the first area to the surroundings of the second object.

According to an embodiment, the operation of the electronic device when an event occurs in an application mapped to a border of the display is described below with reference to FIGS. 9A to 9F.

According to an embodiment, upon reception of a swipe starting from a first border of the display mapped to the event occurring application, the electronic device may control the display to display the execution screen of the event occurring application. For example, the electronic device may control the display to allow the execution screen of the application to appear to enter the display from outside the first border of the display in the swiping direction based on the swipe.

According to an embodiment, the second object displayed in the second area when the event occurs may include an icon related to the event occurring application. For example, when an event occurs in a message application, the second object may include a message-shaped icon and, when an event occurs in a content playback application, the second object may include an icon including a play symbol (e.g., [symbol] ).

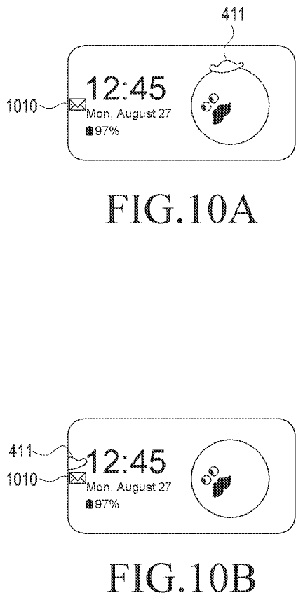

According to an embodiment, when the second object includes an icon related to the event occurring application, the electronic device may move at least a portion of the first object from the first area to the surroundings of the icon. According to an embodiment, the operation of the electronic device when the second object includes an icon is described below with reference to FIGS. 10A and 10B.

According to an embodiment, if no user input for executing an event-related application is received, the electronic device may repeat the operation of moving at least a portion of the first object from the first area to the second area at a set cycle.

FIG. 4A is a view illustrating an event notification operation according to an embodiment of the disclosure. For example, FIG. 4A illustrates a screen displayed on a cover screen (e.g., the sub display 239 of FIGS. 2A to 2C) in a folded state of the electronic device which is a foldable device.

Referring to FIG. 4A, the electronic device (e.g., the electronic device 101 of FIG. 1, the processor 120 of FIG. 1, or the foldable device 200 of FIG. 2A) may display a first object 410 including the status of the electronic device in a first area 420 which is a portion of the display (e.g., the display module 160 of FIG. 1, the sub display 239 of FIG. 2A, the sub display 239 of FIG. 2B, or the sub display 239 of FIG. 2C). For example, a portion 411 of the first object 410 may be moved.

According to an embodiment, the electronic device may control the display to further display a time object 412 along with the first object 410. According to an embodiment, the electronic device may control the display to further display the time object 412, a date object, or a battery charge amount object.

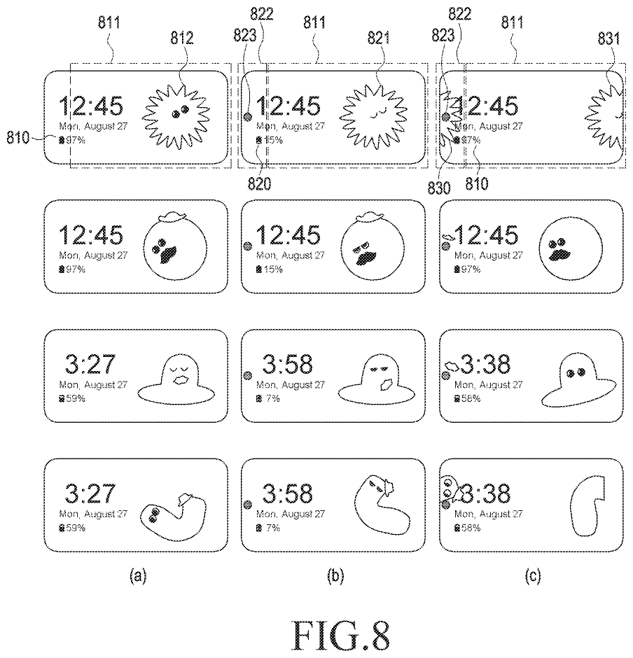

According to an embodiment, the first object 410 may include a character image, and it may include different character images depending on battery charge amounts. For example, if the battery charge amount is a set value (e.g., 15%) or more, the first object 410 may include the character image shown in FIG. 4A and, if the battery charge amount is less than the set value, the first object may include the character image shown in FIG. 8. According to an embodiment, the operation of displaying different first objects depending on battery charge amounts is described below with reference to FIGS. 6 to 8.

FIG. 4B is a view illustrating an event notification operation according to an embodiment of the disclosure. For example, FIG. 4A illustrates a screen displayed on a cover screen (e.g., the sub display 239 of FIGS. 2A to 2C) in a folded state of the electronic device which is a foldable device.

Referring to FIG. 4B, if an event occurs, the electronic device may display a second object 430 in a portion of a second area 421 different from the first area (e.g., the first area 420 of FIG. 4B) of the display. For example, the second object 430 may be one to indicate that a new event occurs, and it may include a figure shape, e.g., a dot shape, or an icon shape related to the event occurring application.

According to an embodiment, the electronic device may control the display to move the portion 411 of the first object to the second area 421. For example, the electronic device may control the display to allow the portion 411 of the first object 410 to appear to fly around the second object 430 displayed in the second area 421.

FIG. 4C is a view illustrating an event notification operation according to an embodiment of the disclosure. For example, FIG. 4A illustrates a screen displayed on a cover screen (e.g., the sub display 239 of FIGS. 2A to 2C) in a folded state of the electronic device which is a foldable device.

Referring to FIG. 4C, the electronic device may control the display to allow the portion 411 of the first object (e.g., the first object 410 of FIGS. 4A and 4B) to be moved from the first area (e.g., the first area 420 of FIG. 4A) to the second area (e.g., the second area 421 of FIG. 4B) and displayed around the second object 430 displayed in the second area.

According to an embodiment, upon reception of a user input for executing the event-related application after the event occurs, the electronic device may control the display to display the execution screen of the application related to the event. For example, upon reception of a user input of selecting the second object 430, the electronic device may control the display to display the execution screen of the event occurring application as shown in FIG. 5.

According to an embodiment, if no user input for executing the event-related application is received after the event occurs, the electronic device may repeat the operation of moving the portion 411 of the first object (e.g., the first object 410 of FIG. 4A or 4B) from the first area (e.g., the first area 420 of FIG. 4A) to the second area (e.g., the second area 421 of FIG. 4B) at a set cycle.

Although a screen displayed on the cover screen of the foldable device is shown and described with reference to FIGS. 4A to 4C, if the electronic device is a bar-shaped electronic device or a slidable electronic device, the screen of FIGS. 4A to 4C may be displayed on the standby screen (e.g., a state in which only a partial area of the display is active).

As described above, according to an embodiment of the disclosure, when an event occurs, the electronic device may effectively notify the user of the occurrence of the event by moving a portion of an object displayed on the display.

FIG. 5 is a view illustrating an operation of displaying an application where an event occurs according to an embodiment of the disclosure.

Referring to FIG. 5, upon reception of a user input for executing an application related to an event after the event occurs, the electronic device (e.g., the electronic device 101 of FIG. 1, the processor 120 of FIG. 1, or the foldable device 200 of FIG. 2A) may control the display (e.g., the display module 160 of FIG. 1, the sub display 239 of FIG. 2A, the sub display 239 of FIG. 2B or the sub display 239 of FIG. 2C) to display an execution screen of the event-related application.

For example, upon reception of a touch or swipe of a portion (e.g., the portion 411 of the first object of FIG. 4C) of the first object moved to the second area (e.g., the second area 421 of FIG. 4B) of the display based on the occurrence of the event or a touch or swipe on the second object (e.g., the second object 430 of FIG. 4C) displayed in the second area of the display based on the occurrence of the event, the electronic device may control the display to display the execution screen of the application related to the event.

For example, in a case where an event of receiving a new message occurs, if a user input for executing the event-related application is received, the electronic device may control the display to display the execution screen of the message application including the newly received message 510.

FIG. 6 is a flowchart illustrating an event notification operation based on a state of an electronic device according to an embodiment of the disclosure.

Referring to FIG. 6, in operation 601, an electronic device (e.g., the electronic device 101 of FIG. 1, the processor 120 of FIG. 1, or the foldable device 200 of FIG. 2A) may identify whether the battery charge amount is a set value (e.g., 15%) or more.

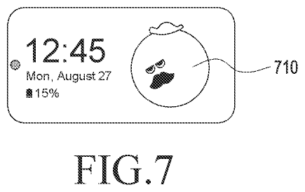

According to an embodiment, if the battery charge amount is less than the set value (No in operation 601), the electronic device may represent a state of being out of battery in operation 602. For example, as shown in FIG. 7 or part (b) of FIG. 8, the electronic device may control the display (e.g., the display module 160 of FIG. 1, the sub display 239 of FIG. 2A, the sub display 239 of FIG. 2B, or the sub display 239 of FIG. 2C) to display an object including a second character image (e.g., a sleepy expression or the text ZZZ) representing the out-of-battery status.

FIG. 7 is a view illustrating an object which is displayed when a battery charge amount of an electronic device is less than a set value according to an embodiment of the disclosure.

Referring to FIG. 7, if the battery charge amount is less than a set value, the electronic device (e.g., the electronic device 101 of FIG. 1, the processor 120 of FIG. 1, or the foldable device 200 of FIG. 2A) may control the display (e.g., the display module 160 of FIG. 1, the sub display 239 of FIG. 2A, the sub display 239 of FIG. 2B, or the sub display 239 of FIG. 2C) to display an object including a second character image 710 (e.g., a sleepy expression or the text ZZZ) representing the out-of-battery status.

Referring back to FIG. 6, according to an embodiment, if the battery charge amount is the set value or more (Yes in operation 601), the electronic device may display the object in a normal state in operation 603. For example, as shown in FIG. 4A to 4C or part (a) of FIG. 8, the electronic device may control the display to display an object including a first character image (e.g., the first object 410 of FIGS. 4A and 4B) representing the normal state.

According to an embodiment, in operation 604, the electronic device may identify whether an event occurs. For example, the electronic device may identify whether a new notification occurs, such as reception of a new message, an alarm, and/or content recommendation.

According to an embodiment, if an event is identified to occur (Yes in operation 604), the electronic device may control the display to move a portion of the object to the second area in operation 605. For example, if the event is identified to occur, the electronic device may control the display to move a portion (e.g., the portion 411 of the first object of FIG. 4A) of the object to the second area (e.g., the second area 421 of FIG. 4B) of the display.

According to an embodiment, if an event occurs, the electronic device may control the display to display a second object (e.g., the second object 430 of FIG. 4B) indicating that the event occurs, in the second area and move the portion (e.g., the portion 411 of the first object of FIG. 4A) of the object to the second area (e.g., the second area 421 of FIG. 4B) of the display.

According to an embodiment, in operation 606, the electronic device may identify whether an event is identified. For example, the electronic device may identify whether an execution screen of an application related to the occurring event is displayed based on reception of a user input.

For example, the electronic device may identify whether the execution screen of the event-related application is displayed based on reception of a user input for a touch or swipe on the second object displayed in the second area or a touch or swipe on the portion of the object moved to the second area.

According to an embodiment, if the event is not identified (No in operation 606), the electronic device may proceed to operation 605, repeating the operation of moving the portion of the object to the second area. For example, if a user input for identifying an event is not received despite providing a notification for an occurrence of an event by the operation of moving a portion of an object and/or displaying the second object, the electronic device may repeat the operation of moving a portion of the object to the second area, thereby repeatedly indicating that the event has occurred.

According to an embodiment, if it is identified that no event occurs (No in operation 604), the electronic device may control the display to allow the object to be moved only in the first area of the display. For example, if it is identified that no event occurs, the electronic device may control the display to allow an object (e.g., the first object 410 and portion 411 of the first object of FIG. 4A) to be moved only in the first area (e.g., the first area 420 of FIG. 4A) as shown in FIG. 4A.

According to an embodiment, if an event is identified (Yes in operation 606), the electronic device may proceed to operation 607 and control the display to allow the object to be moved only in the first area. For example, since there is no event requiring the user to identify after the event is identified, the electronic device may control the display to allow the object to be moved only in the first area like in the state where no event occurs.

According to an embodiment, operations 604 to 607 are performed when the battery charge amount is the set value or more and, if the battery charge amount is less than the set value, the operations may not be performed to preserve the battery charge amount. For example, if an event occurs while the battery charge amount is less than the set value, the electronic device may display only the second object indicating the occurrence of the event in the second area of the display and may not perform the operation of moving the portion of the object, displayed in the first area, to the second area.

As described above, it is possible to more effectively transfer the state of the electronic device to the user by differently representing the object displayed in the first area depending on the battery charge amount and moving a portion of the object, displayed in the first area, to the second area when an event occurs.

FIG. 8 is a view illustrating an object displayed when a new event occurs or when a battery charge amount is less than a set value according to an embodiment of the disclosure.

According to an embodiment, part (a) of FIG. 8 illustrates various embodiments of an object 812 displayed on a display (e.g., the display module 160 of FIG. 1, the sub display 239 of FIG. 2A, the sub display 239 of FIG. 2B, or the sub display 239 of FIG. 2C) while the battery charge amount 810 is a set value or more and no event occurs. According to an embodiment, the electronic device (e.g., the electronic device 101 of FIG. 1, the processor 120 of FIG. 1, or the foldable device 200 of FIG. 2A) may display the object 812 in a first area 811 (e.g., the first area 420 of FIG. 4A) of the display, and the object 812 may be moved only in the first area 811.

According to an embodiment, part (b) of FIG. 8 illustrates various embodiments of an object displayed when the battery charge amount is less than the set value.

Referring to part (b) of FIG. 8, if the battery charge amount 820 is less than the set value, the electronic device (e.g., the electronic device 101 of FIG. 1, the processor 120 of FIG. 1, or the foldable device 200 of FIG. 2A) may display an object 821 different in shape (e.g., a tired face) from the object 812 as shown in part (a) of FIG. 8 in the first area 811 (e.g., the first area 420 of FIG. 4A).

According to an embodiment, in a case where the battery charge amount 820 is less than the set value, if an event occurs, the electronic device may display a second object 823 (e.g., the second object 430 of FIG. 4B) indicating the occurrence of the event in the second area 822 (e.g., the second area 421 of FIG. 4B) of the display, and the object 821 displayed in the first area 811 may be moved only in the first area 811.

According to an embodiment, part (c) of FIG. 8 illustrates various embodiments of an object displayed on the display when the battery charge amount is the set value or more and an event occurs.

Referring to part (c) of FIG. 8, if an event occurs while the battery charge amount 810 is the set value or more, the electronic device may control the display to move a portion 830 of the object, displayed in the first area 811, to the second area 822 and display a remaining portion 831 of the object except for the portion 830 of the object in the first area 811. According to an embodiment, in a case where the second object 823 is displayed in the second area 822 as an event occurs, the electronic device may control the display to move the portion 830 of the object displayed in the first area 811 to the surroundings of the second object 823.

FIG. 9A is a view illustrating an application mapped to be executed by a swipe on a border of a display according to an embodiment of the disclosure.

Referring to FIG. 9A, the electronic device (e.g., the electronic device 101 of FIG. 1, the processor 120 of FIG. 1, or the foldable device 200 of FIG. 2A) may respectively map a plurality of applications to a plurality of borders of the display to be executed through a swipe starting at a border of the display (e.g., the display module 160 of FIG. 1, the sub display 239 of FIG. 2A, the sub display 239 of FIG. 2B, or the sub display 239 of FIG. 2C).

For example, the electronic device may map a first application (e.g., a message application) to a first border (e.g., a left border) of the display, a second application (e.g., a music playback application) to a second border (e.g., a right border) of the display, a third application (e.g., a settings application) to a third border (e.g., a top border) of the display, and a fourth application (e.g., a payment application) to a fourth border (e.g., a bottom border) of the display.

According to an embodiment, upon receiving a user input of swiping from the first border of the display in a first direction (e.g., a right direction) while a standby screen 910 is displayed on the display, the electronic device may control the display to display the execution screen (e.g., the execution screen 911 of the message application) of the first application and, upon receiving a user input of swiping from the second border of the display in a second direction (e.g., a left direction), control the display to display the execution screen (e.g., the execution screen 912 of the music playback application) of the second application. According to an embodiment, upon receiving a user input of swiping from the third border of the display in a third direction (e.g., a lower direction) while the standby screen 910 is displayed on the display, the electronic device may control the display to display the execution screen (e.g., the execution screen 913 of the settings application) of the third application and, upon receiving a user input of swiping from the fourth border of the display in a fourth direction (e.g., an upper direction), control the display to display the execution screen (e.g., the execution screen 914 of the payment application) of the fourth application.

Although it has been described above that when a swipe is performed from one border of the display, the execution screen of the corresponding application is displayed, according to an embodiment, if the swiping direction and the application are mapped, the electronic device may display the execution screen of the application corresponding to the swiping direction even when a swipe, which does not start from one border of the display, is performed.

For example, upon receiving a user input of swiping in the first direction (e.g., the right direction) while the standby screen 910 is displayed, the electronic device may control the display to display the execution screen (e.g., the execution screen 911 of the message application) of the first application, upon receiving a user input of swiping in the second direction (e.g., the left direction), the electronic device may control the display to display the execution screen (e.g., the execution screen 912 of the music playback application) of the second application, upon receiving a user input of swiping in the third direction (e.g., the lower direction), the electronic device may control the display to display the execution screen (e.g., the execution screen 913 of the settings application) of the third application, and upon receiving a user input of swiping in the fourth direction (e.g., the upper direction), the electronic device may control the display to display the execution screen (e.g., the execution screen 914 of the payment application) of the fourth application.

According to an embodiment, upon receiving a swipe, the electronic device may control the display to display the application screen to appear to enter the display in the swiping direction from outside the border of the display.

According to an embodiment, although FIG. 9A illustrates that applications are respectively mapped to all of the four borders of the display, applications may be respectively mapped to only three or fewer borders.

According to an embodiment, operations when an event occurs in at least one application among applications respectively mapped to the borders of the display as shown in FIG. 9A are described with reference to FIGS. 9B to 9F.

FIG. 9B is a view illustrating an event notification operation according to an embodiment of the disclosure. For example, FIG. 9B illustrates a case where an event occurs in the application mapped to the left border, with applications respectively mapped only to the left and right borders of the display. According to an embodiment, FIG. 9B may also be applicable where an event occurs in the application mapped to a swipe in the right direction, with applications respectively mapped only to swipes in the right direction and left direction.

Referring to FIG. 9B, the display may include a first area 920 and a plurality of second areas 921-1 and 921-2. For example, the plurality of second areas 921-1 and 921-2 may be disposed on the left and right, respectively, of the first area 920.

According to an embodiment, the first object 410 and a portion 411 of the first object 410 may be moved only in the first area 920 while no event occurs.

According to an embodiment, if an event occurs in the application mapped to the left border of the display, the electronic device may display a second object 930 indicating the occurrence of the event in the second area 921-1 including the left border of the display. For example, the second object 930 may be one to indicate that a new event occurs, and it may include a figure shape, e.g., a dot shape, or an icon shape related to the event occurring application.

According to an embodiment, the electronic device may control the display to move the portion 411 of the first object 410, displayed in the first area 920, to the second area 921-1. For example, as shown in FIG. 4C, the electronic device may control the display to display the portion 411 of the first object 410, displayed in the first area 920, to appear to fly around the second object 930 displayed in the second area 921-1 including the left border of the display.

FIG. 9C is a view illustrating an event notification operation according to an embodiment of the disclosure.

FIG. 9D is a view illustrating an event notification operation according to an embodiment of the disclosure. For example, FIGS. 9C and 9D illustrate a case where an event occurs in the application mapped to the right border, with applications respectively mapped only to the left and right borders of the display.

Referring to FIG. 9C, if an event occurs in the application mapped to the right border of the display, the electronic device may display a second object 931 indicating the occurrence of the event in the second area 921-2 including the right border of the display. For example, the second object 931 may be one to indicate that a new event occurs, and it may include a figure shape, e.g., a dot shape, or an icon shape related to the event occurring application.

According to an embodiment, the electronic device may control the display to move the portion 411 of the first object 410, displayed in the first area 920, to the second area 921-2 including the right border of the display. For example, as shown in FIG. 9D, the electronic device may control the display to display the portion 411 of the first object, displayed in the first area 920, to appear to fly around the second object 931 displayed in the second area 921-2 and to display the rest 940 of the first object 410 in the first area.

FIG. 9E is a view illustrating an event notification operation according to an embodiment of the disclosure.

FIG. 9F is a view illustrating an event notification operation according to an embodiment of the disclosure. For example, FIGS. 9E and 9F illustrate a case where an event occurs in both the applications mapped to the left and right borders, with applications respectively mapped only to the left and right borders of the display.

Referring to FIG. 9E, if an event occurs in the applications mapped to the left and right borders of the display, the electronic device may display second objects 930 and 931 indicating the occurrence of the event in the second area including the left border of the display and the second area including the right border of the display. For example, the second objects 930 and 931 may be ones to indicate that a new event occurs, and they may include a figure shape, e.g., a dot shape, or an icon shape related to the event occurring application.

According to an embodiment, the electronic device may control the display to move the portion 411 of the first object 410, displayed in the first area, to each of the second area including the left border of the display and the second area including the right border of the display. For example, the electronic device may move the portion 411 of the first object 410 displayed in the first area to the surroundings of the second object 930 displayed in the second area including the left border of the display, then delete the portion 411 of the first object moved to the surroundings of the second object 930, and move the portion 411 of the first object 410, displayed in the first area, to the surroundings of the second object 931 displayed in the second area including the right border of the display.

Referring to FIG. 9F, according to an embodiment, the electronic device may control the display to move a first portion 411-1 of a portion of the first object displayed in the first area 920 to the surroundings of the second object 930 displayed in the second area including the left border of the display, move a second portion 411-2 of the portion of the first object to the surroundings of the second object 931 displayed in the second area including the right border of the display, and display the rest 940 of the first object in the first area.

FIG. 10A is a view illustrating an event notification operation when an icon corresponding to an application where an event occurs is displayed according to an embodiment of the disclosure.

FIG. 10B is a view illustrating an event notification operation when an icon corresponding to an application where an event occurs is displayed according to an embodiment of the disclosure. For example, FIGS. 10A and 10B illustrate an embodiment in which a second object indicating an occurrence of an event includes an icon related to the event occurring application.

Referring to FIG. 10A, if an event occurs, with a first object (e.g., the first object 410 of FIG. 4A and a portion 411 of the first object) displayed in a first area (e.g., the first area 420 of FIG. 4A) of a display (e.g., the display module 160 of FIG. 1, the sub display 239 of FIG. 2A, the sub display 239 of FIG. 2B, or the sub display 239 of FIG. 2C), an electronic device (e.g., the electronic device 101 of FIG. 1, the processor 120 of FIG. 1, or the foldable device 200 of FIG. 2A) may control the display to display a second object 1010 (e.g., the second object 430 of FIG. 4B) indicating the occurrence of the event in a second area (e.g., the second area 421 of FIG. 4B) of the display. According to an embodiment, the second object 1010 may include an icon related to the event occurring application. For example, if a new message is received, the second object 1010 may include an icon related to the message application.

Referring to FIG. 10B, according to an embodiment, the electronic device may control the display to move the portion 411 of the first object, displayed in the first area, to the surroundings of the second object 1010 displayed in the second area.

As such, when the second object indicating the occurrence of an event is related to the event occurring application, it is possible to effectively provide information about the event occurring application while notifying the user of the occurrence of the event.

According to an embodiment, an electronic device (e.g., the electronic device 101 of FIG. 1, the processor 120 of FIG. 1, or the foldable device 200 of FIG. 2A) may comprise a memory (e.g., the memory 130 of FIG. 1), a display (e.g., the display module 160 of FIG. 1, the sub display 239 of FIG. 2A, the sub display 239 of FIG. 2B, or the sub display 239 of FIG. 2C) and at least one processor (e.g., the processor 120 of FIG. 1) coupled to the memory and the display. The memory may store instructions to, when executed by the at least one processor, enable the electronic device to, display a first object (e.g., the first object 410 of FIG. 4A) including a status of the electronic device in a first area (e.g., the first area 420 of FIG. 4A) which is a portion of the display and, when an event occurs, move at least a portion (e.g., the portion 411 of the first object of FIG. 4A) of the first object from the first area to a second area (e.g., the second area 421 of FIG. 4B) in the display, the second area being different from the first area.

According to an embodiment, the at least one processor may display a second object (e.g., the second object 430 of FIG. 4B) indicating the occurrence of the event in a portion of the second area if the event occurs and move at least a portion of the first object from the first area to a surrounding of the second object.

According to an embodiment, the at least one processor may, when there are a plurality of applications respectively mapped to a plurality of directions of a swipe to be executed through a swipe input on the display, and the event occurs in one among the plurality of applications, display the second object in a second area corresponding to a first direction of the display corresponding to the event occurring application among a plurality of second areas corresponding to the plurality of directions, respectively, and including a plurality of borders of the display, respectively.

According to an embodiment, the at least one processor may control the display to display an execution screen of the event occurring application if a swipe input is performed in the first direction.

According to an embodiment, the at least one processor may control the display to display a screen of the event occurring application if a touch input being performed in the second object is received.

According to an embodiment, the second object may include an icon related to the event occurring application. The at least one processor may move at least a portion of the first object from the first area to a surrounding of the icon.

According to an embodiment, the at least one processor may repeat, at a set cycle, moving the at least a portion of the first object from the first area to the second area if a user input for executing an application related to the event is not received.

According to an embodiment, the at least one processor may identify a battery charge amount, control the display to display the first object including a first character image if the battery charge amount is a set value or more, and control the display to display the first object including a second character image different from the first character image if the battery charge amount is less than the set value.

According to an embodiment, the at least one processor may control the display to display the first object only in the first area if the event does not occur.

According to an embodiment, the electronic device may be a foldable electronic device. The display may be a cover screen of the foldable electronic device.

According to an embodiment, a method for controlling an electronic device (e.g., the electronic device 101 of FIG. 1, the processor 120 of FIG. 1, or the foldable device 200 of FIG. 2A) may comprise displaying a first object including a status of the electronic device in a first area which is a portion of a display (e.g., the display module 160 of FIG. 1, the sub display 239 of FIG. 2A, the sub display 239 of FIG. 2B, or the sub display 239 of FIG. 2C) of the electronic device and, when an event occurs, moving at least a portion of the first object from the first area to a second area in the display, the second area being different from the first area.

According to an embodiment, the moving may include displaying a second object indicating the occurrence of the event in a portion of the second area if the event occurs, and moving the at least the portion of the first object from the first area to a surrounding of the second object.

According to an embodiment, the moving may include, when there are a plurality of applications respectively mapped to a plurality of directions of a swipe to be executed through a swipe input on the display, and the event occurs in one among the plurality of applications, displaying the second object in a second area corresponding to a first direction of the display corresponding to the event occurring application among a plurality of second areas corresponding to the plurality of directions, respectively, and including a plurality of borders of the display, respectively.

According to an embodiment, the method may further comprise displaying an execution screen of the event occurring application if the swipe input is performed in the first direction.

According to an embodiment, the method may further comprise displaying a screen of the event occurring application if a touch input being performed in the second object is received.

According to an embodiment, the second object may include an icon related to the event occurring application. The moving may include moving at least a portion of the first object from the first area to a surrounding of the icon.

According to an embodiment, the method may further comprise repeating, at a set cycle, moving the at least the portion of the first object from the first area to the second area if a user input for executing an application related to the event is not received.

According to an embodiment, displaying the first object may include identifying a battery charge amount, displaying the first object including a first character image if the battery charge amount is a set value or more, and displaying the first object including a second character image different from the first character image if the battery charge amount is less than the set value.

According to an embodiment, the first object may be displayed only in the first area if the event does not occur.

According to an embodiment, the electronic device may be a foldable electronic device. The display may be a cover screen of the foldable electronic device.

The electronic device according to various embodiments of the disclosure may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
a memory;
a display; and
at least one processor coupled to the memory and the display,
wherein the memory stores instructions configured to, when executed by the at least one processor, enable the electronic device to:
display a first object including a status of the electronic device in a first area which is a portion of the display, and
in response to an event occurring, move at least a portion of the first object from the first area to a second area in the display, the second area being different from the first area.

2. The electronic device of claim 1,
wherein the instructions are further configured to enable the electronic device to display a second object indicating the occurrence of the event in a portion of the second area in response to the event occurring, and
wherein, to move the at least the portion of the first object from the first area to the second area, the instructions are further configured to move the at least the portion of the first object from the first area to a surrounding of the second object.

3. The electronic device of claim 2, wherein the instructions are further configured to enable the electronic device to:
based on a plurality of applications respectively mapped to a plurality of directions of a swipe to be executed through a swipe input on the display, and the event occurring in one among the plurality of applications, display the second object in a second area corresponding to a first direction of the display corresponding to the event occurring application among a plurality of second areas corresponding to the plurality of directions, respectively, and including a plurality of borders of the display, respectively.

4. The electronic device of claim 3, wherein the instructions are further configured to enable the electronic device to control the display to display an execution screen of the event occurring application in response to the swipe input being performed in the first direction.

5. The electronic device of claim 2, wherein the instructions are further configured to enable the electronic device to control the display to display a screen of the event occurring application in response to a touch input being performed in the second object.

6. The electronic device of claim 2,
wherein the second object includes an icon related to the event occurring application, and
wherein, to move the at least the portion of the first object from the first area to the second area, the instructions are further configured to move the at least the portion of the first object from the first area to a surrounding of the icon.

7. The electronic device of claim 1, wherein the instructions are further configured to enable the electronic device to repeat, at a set cycle, moving at least the portion of the first object from the first area to the second area based on a user input for executing an application related to the event being not received.

8. The electronic device of claim 1, wherein the instructions are further configured to enable the electronic device to:
identify a battery charge amount,
control the display to display the first object including a first character image based on the battery charge amount being a set value or more, and
control the display to display the first object including a second character image different from the first character image based on the battery charge amount being less than the set value.

9. The electronic device of claim 1, wherein the instructions are further configured to enable the electronic device to control the display to display the first object only in the first area based on the event not occurring.

10. The electronic device of claim 1,
wherein the electronic device is a foldable electronic device, and
wherein the display is a cover screen of the foldable electronic device.

11. A method for controlling an electronic device, the method comprising:
displaying a first object including a status of the electronic device in a first area which is a portion of a display of the electronic device; and
in response to an event occurring, moving at least a portion of the first object from the first area to a second area in the display, the second area being different from the first area.

12. The method of claim 11, further comprising:
displaying a second object indicating the occurrence of the event in a portion of the second area in response to the event occurring,
wherein the moving comprises moving the at least the portion of the first object from the first area to a surrounding of the second object.

13. The method of claim 12, wherein the moving includes:
based on a plurality of applications respectively mapped to a plurality of directions of a swipe to be executed through a swipe input on the display, and the event occurring in one among the plurality of applications, displaying the second object in a second area corresponding to a first direction of the display corresponding to the event occurring application among a plurality of second areas corresponding to the plurality of directions, respectively, and including a plurality of borders of the display, respectively.

14. The method of claim 13, further comprising displaying an execution screen of the event occurring application if the swipe input is performed in the first direction.

15. The method of claim 12, further comprising displaying a screen of the event occurring application in response to a touch input being performed in the second object.

16. The method of claim 12,
wherein the second object includes an icon related to the event occurring application, and
wherein the moving comprises moving the at least the portion of the first object from the first area to a surrounding of the icon.

17. The method of claim 11, further comprising repeating, at a set cycle, moving at least the portion of the first object from the first area to the second area based on a user input for executing an application related to the event being not received.

18. The method of claim 11, wherein the displaying of the first object comprises:
identifying a battery charge amount;
displaying the first object including a first character image based on the battery charge amount being a set value or more; and
displaying the first object including a second character image different from the first character image based on the battery charge amount being less than the set value.

19. The method of claim 11, wherein the first object is displayed only in the first area based on the event not occurring.

20. The method of claim 11,
wherein the electronic device is a foldable electronic device, and
wherein the display is a cover screen of the foldable electronic device.
